(19) United States
(12) Patent Application Publication
(10) Pub. No.: US 2007/0121724 A1
(43) Pub. Date: May 31, 2007

(54) Image motion compensation arrangement and method therefor

(75) Inventors: Cornelis C.A.M. Van Zon, Cold Spring, NY (US); Sandeep M. Dalal, Cortlandt Manor, NY (US); John Edward Dean, Stormville, NY (US); Lilla Boroczky, Mt. Kisco, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN NETHERLANDS (NL)

(21) Appl. No.: 10/586,179

(22) PCT Filed: Jan. 24, 2005
(86) PCT No.: PCT/IB05/50276

§ 371 Date: Jul. 17, 2006

Related U.S. Application Data
(60) Provisional application No. 60/539,784, filed on Jan. 27, 2004.

(51) Int. Cl. H04N 11/02; H04N 7/12

(52) U.S. Cl. 375/240.16; 375/240.26

(57) ABSTRACT

Example embodiments are directed to a video image display system that includes a motion estimation circuit (112), a front-end motion compensation circuit (110), and a video signal conversion circuit (134, 136). The motion estimation circuit generates motion vectors as a function of an incoming video signal, the front-end motion compensation circuit receives and processes the incoming video signal as a function of the motion vectors for general video display, and the video signal conversion circuit receives the processed video signal from the front-end motion compensation circuit and generates a display signal for a specific video display as a function of both the processed video signal and the motion vectors. In one implementation, a scaler (120) is implemented to scale the video signal for a particular display type, with components of the motion compensation being implemented for use with the scaler.

This application is directed to image processing and, more particularly, to image processing involving motion compensation.

Imaging equipment, such as video and film cameras, typically records moving video as a stream of pictures. Each picture in the stream represents a recorded scene at a given time. If a display device used for playback of this stream preserves the temporal distance between the pictures, the original smooth motion is preserved; this is for instance the case for some traditional cathode ray tube (CRT) displays. Several display technologies, however, rely on portraying either the color components (e.g., RGB) that make up each picture, or the gray values that make up each color, in time-sequential fashion. An example of the former is a single-panel liquid crystal on silicon (LCoS) projector; examples of the latter are plasma and digital light processing (DLP) displays. In many applications, principles that apply to the former LCoS projector also apply to plasma and DLP displays.

In many display applications including television display applications, characteristics of the processing and display of video signals that result in unwanted video aberrations called artifacts. Artifacts in analog video signals may include, for example, shadowed or snowy images. With digital video signals, artifacts often occur as abrupt changes in portions of a display, discoloration or color breakup in portions of a display. In many digital applications such as those using the Moving Picture Experts Group (MPEG) standards, these and other artifacts occur as a result of signal compression or the speed that with which frames are sequentially presented.

In a single-panel LCoS display, the signals representing the primary colors are displayed sequentially, e.g., R followed by G followed by B. In addition, in order to minimize the so-called “color breakup” artifact, the display frame rate is increased relative to the picture rate, e.g., from 60 Hz to 180 Hz. In this particular case, each incoming picture, representing a single moment in time, is displayed as 3 frames (180/60)×3 color fields per frame (RGB)=9 sequential fields. For example, two consecutive pictures RGB[t] RGB[t+T₁] at time t get displayed as R[t] G[t+T₂] B[t+2T₂] R[t+3T₂] G[t+4T₂] B[t+5T₂] R[t+6T₂] G[t+7T₂] B[t+8T₂] R[t+T₁] G[t+T₁+T₂], etc., with T₁ equal to the time between the original pictures and T₂=T₁/9. This illustrates how eight out of nine color components get displayed at the wrong moment in time (i.e., not at time t), leading to a visible artifact called motion judder. Motion portrayal can be improved by applying motion compensated frame rate upconversion, a technique in which the correct motion phases are calculated by interpolation between incoming pictures using motion vectors.

For background information regarding motion compensation, reference can be made to the following patent documents: DE 195 10 389 to Siemens A. G., U.S. Pat. Nos. 6,208,760 and 6,278,736 to De Haan, et al., each being fully incorporated herein by reference. While such motion compensation approaches can be implemented to address and/or correct improper timing issues, they often require specific circuits and other supporting items to be implemented. Many motion compensation approaches are generally complex and/or unduly expensive. In many applications, such as those involving plasma displays, the cost of motion compensation is prohibitive to its implementation.

Various aspects of the present invention are directed to motion compensation, and in a more specific application, to motion compensation involving the generation of motion vectors.

According to an example embodiment of the present invention, a video image display system includes a motion estimation circuit, a front-end motion compensation circuit, and a video signal conversion circuit. The motion estimation circuit generates motion vectors as a function of an incoming video signal, the front-end motion compensation circuit processes the incoming video signal as a function of the motion vectors for general video display, and the video signal conversion circuit uses the processed video signal from the front-end motion compensation circuit to generate a display signal for a specific video display as a function of both the processed video signal and the motion vectors.

Other aspects of the present invention are directed to more specific example implementations of the above circuits and to related methodology for processing the motion estimation data at the communicating terminals.

The above summary is not intended to describe each illustrated embodiment or every implementation of the present invention. The figures and the detailed description that follow more particularly exemplify these embodiments.

The invention may be more completely understood in consideration of the following detailed description of various embodiments of the invention in connection with the accompanying drawings, in which:

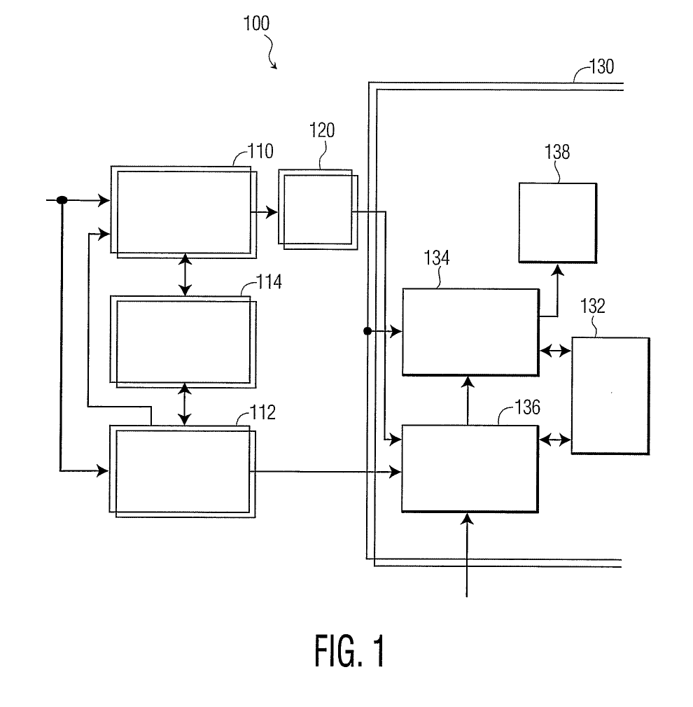

FIG. 1 is a block diagram showing a motion-compensation system, according to an example embodiment of the present invention;

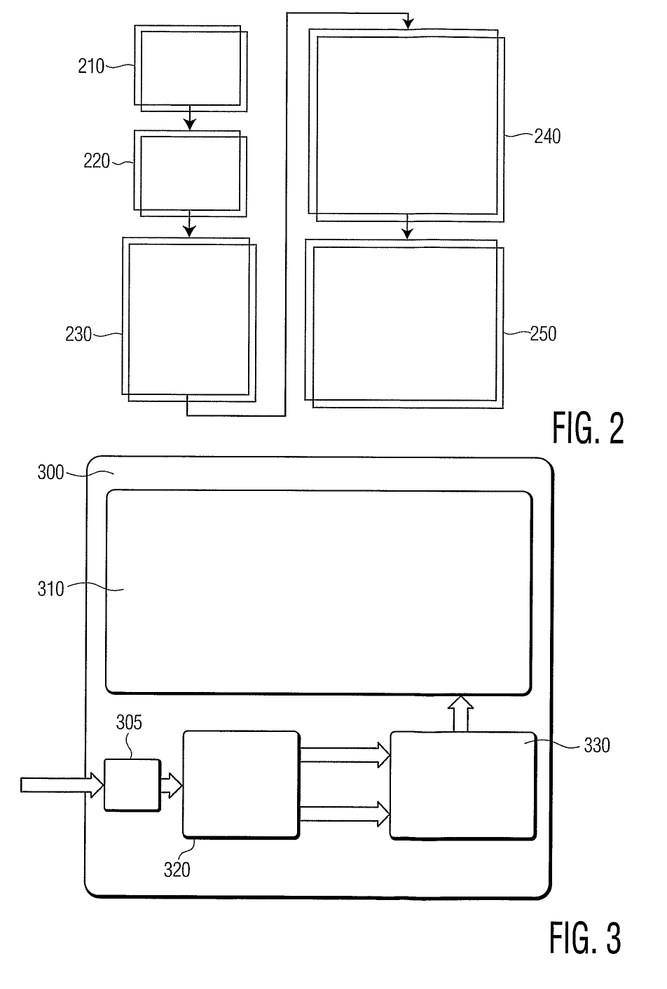

FIG. 2 is a flow diagram for a motion compensation approach, according to another example embodiment of the present invention; and

FIG. 3 is a display having motion compensation circuitry, according to another example embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

The present invention is believed to be highly applicable to image processing, and the invention has been found to be particularly advantageous for motion compensation. While the present invention is not necessarily limited to such applications, an appreciation of various aspects of the invention is best gained through a discussion of examples in such an environment.

According to an example embodiment of the present invention, video images to be shown on a display are processed using a motion compensation approach involving the re-use of motion estimation processing at the display. A motion estimation signal including motion vectors is generated at front-end type circuitry that processes a video signal for further use by a display system. Such front-end type circuitry may include one or more of a variety of circuits that employ motion estimation such as a field or frame rate upconversion circuit (e.g., film to video, i.e., 24 Hz to 60 Hz) a noise reduction circuit and/or a deinterlacing circuit.

The motion estimation signal is used by the front-end type circuitry and also sent to display circuitry that receives the video signal processed by the front-end type circuitry. The display circuitry is configured to use the motion estimation signal to compensate for motion-related display conditions, such as those discussed above. In some instances, the motion estimation signal is adjusted to suit particular characteristics of the display, such as resolution and temporal phase. With this approach, motion estimation can be re-used, thus reducing circuit and/or memory requirements for generating additional motion estimation signals.

In various implementations, motion vectors are adjusted for the specific display resolution and temporal phases required for upconversion where appropriate. Specifically, display-specific characteristics such as resolution, display size/shape and spatio-temporal relationships are taken into consideration when adjusting the motion vectors, as is conventional.

FIG. 1 is a block diagram showing system 100 employing motion compensation, according to another example embodiment of the present invention. The system 100 includes a front end motion compensation circuit 110 coupled to a motion estimation circuit 112 and a memory 114 and adapted to generate a video signal for use by a display system 130. The motion compensation circuit 110 and the motion estimation circuit 112 are both coupled to receive an incoming video signal and to use information stored in the memory 114. The motion estimation circuit 112 is configured to process the incoming video signal using information in the memory 114 to generate motion vectors. The motion vectors are used by the motion compensation circuit 110, along with information in the memory 114, to generate a signal for a display system 130. The signal generated for the display system 130 is typically useful for variety of types of displays, with further processing of the generated signal being carried out at the display system for tailoring the signal to particular characteristics of the display. Optionally, a spatial scaler 120 is used between the motion compensation circuit 110 and the display system 130 to scale the spatial resolution of the output from the motion compensation circuit 110 to match the resolution of the display system 130.

The motion estimation circuit 112 uses one or more of a variety of approaches to generating motion vectors for use in predicting characteristics of an image when different portions of the image are generated sequentially. For example, as discussed above, sequential color display (e.g., with LCoS) or gray value display (e.g., with DLP displays) is susceptible to timing discrepancies associated with the shift in video that occurs over time. In this regard, the motion estimation circuit 112 is adapted to provide an estimate of the proper characteristics of a particular video signal component (e.g., speed and direction of movement) at a time that is different than the time represented by the video frame used to generate the image. With this motion information, the estimated location of the video signal component, relative to a known location of the video signal component, can be determined.

The motion compensation circuit 110 includes one or more of a variety of types of circuitry and functionality. In one implementation, the motion compensation circuit 110 includes a field or frame rate upconversion circuit adapted to convert a video signal to a higher temporal frequency to provide a signal having more information (e.g., frames) per time period (and correspondingly provide a more accurate representation of the video location). In another implementation, the motion compensation circuit 110 includes a deinterlacing circuit adapted to combine interlaced video fields into progressive scan frames. In yet another implementation, the motion compensation circuit 110 includes a combination of both deinterlacing and upconversion functions. The motion compensation circuit 110 is optionally deactivated, depending on the characteristics on the input video (e.g., if upconversion is not needed with the incoming video, the motion compensation circuit 110 may not be needed).

The motion compensation circuit 110 uses the motion vectors from the motion estimation circuit 112 to determine the location of components of a video signal at a particular time instant. For example, where color sequential display is used (e.g., LCoS) with (e.g.) the display of the red component of a video signal (frame) being followed by the display of the green component of the video frame, the display of the green component is effectively delayed. Delay in the display of the green component results in an inaccurate spatio-temporal representation of the green component of the video signal (frame), relative to the red component. In this regard, the motion vectors are used by the motion compensation circuit 110 to estimate (e.g., interpolate) the position of the green components at a time after the red components are displayed. This estimation uses, for example, a stream of video frames leading up to and following the frame being displayed to generate speed and direction motion-related characteristics (via the motion vectors) and accordingly estimate the position of the green component at the time it is to be displayed. This approach facilitates a more time-accurate display of the green components of the video frame.

In one implementation, motion compensated frame rate upconversion, a technique in which correct motion phases are calculated by interpolation between incoming pictures using motion vectors, is used to enhance motion portrayal. This interpolation typically involves the use of motion vectors. For more specific information regarding such motion compensation approaches and systems, and for specific information regarding motion estimation processing that can be implemented in connection with various example embodiments of the present invention, reference can be made to U.S. Pat. Nos. 6,208,760 and 6,278,736 to De Haan, et al., which are fully incorporated herein by reference. This motion compensated frame rate upconversion is implemented using an approach involving the use of motion vectors as discussed herein and, in some instances, re-using motion vectors generated in accordance with an approach discussed in one or both of the above-cited patent documents.

The memory 114 is used to store one or more previous frames for use by the front-end motion compensation circuit 110 to interpolate between consecutive fields or frames. The memory 114 is also used by the motion estimation circuit 112 to estimate the speed and direction of motion between consecutive fields or frames.

The display system 130 includes a motion compensation circuit 134 coupled to receive the signal generated by the motion compensation circuit 110 (and optionally scaled with the spatial scaler 120. The motion compensation circuit 134 is coupled to receive motion information from a motion vector refinement circuit 136 and also to memory 132 that holds video frames to be interpolated as received from the motion compensation circuit 110. The signal generated by the motion compensation circuit 110 is adjusted by the motion compensation circuit 134 to match the characteristics of a video display 138. The video display 138, such as a LCoS panel or a DLP display, is coupled to receive and display the processed video signal from the motion compensation circuit 134.

The motion vector refinement circuit 136 is coupled to receive the motion vectors generated by the motion estimation circuit 112 and processes the motion vectors for use by the motion compensation circuit 134. Processing information used by the motion vector refinement circuit 136 may be stored in the memory 132. In some instances, the motion vector refinement circuit 136 also receives and uses video data from upconversion circuit 110 (or scaling circuit 120) to process the motion vectors for use by the motion compensation circuit 134.

The received motion vectors are effectively tailored by the motion vector refinement circuit 136 as a function of the characteristics of the video display 138. For instance, the motion vectors generated by the motion estimation circuit 112 are generally tailored for the motion compensation circuit 110, which is not necessarily directed to generating a video signal compatible with the video display 138. In this regard, size, resolution, frame rate and other characteristics of the video display are taken into consideration when refining the motion vectors 112. For example, when the motion estimation circuit 112 generates motion vectors that are suitable for a display having an aspect ratio (width:height) that is different than the aspect ratio of the video display 138, the direction and speed indicated by the motion vectors is adjusted accordingly. The spatio-temporal grid of the motion vectors is correspondingly adjusted to match the spatio-temporal grid of the display. These and other refinements are effected using, for example, a control input to the motion vector refinement circuit 136 and may involve the use of stored refinement characteristics. These refinement characteristics may be stored, e.g., in a small ROM that is part of the video display 138 or at an external CPU that also provides the control input (e.g., a CPU embedded in a television employing the video display 138).

In another implementation, the motion compensation circuit 110 includes the functionality of the motion compensation circuit 134 and the motion vector refinement circuit 136, with the memory 114 including data in the memory 132. The signal ultimately generated by the motion compensation circuit 110 is thus implemented directly to the video display 138. In this regard, the motion compensation circuit 110 is specifically tailored in this instance to the type of the video display 138.

FIG. 2 shows another example approach to motion compensation that is directed to a general case where motion vectors are re-used and where the color presentation is sequential. At block 210, a video signal is received at a front-end device such as a device for noise reduction, upconversion and/or deinterlacing. Motion vectors are generated at block 220 using the video signal and representing a speed and direction characteristic of the image content represented by the video signal at a particular time (and thus the motion vectors change over time). At block 230, a motion compensation type function is performed on the video signal using the motion vectors generated at block 220. The result is a processed video signal having video data that is compensated for motion-related characteristics relative to spatio-temporal discrepancies typically associated with the sequential display of different components of a particular video frame.

After the processed video signal has been generated, a motion vector refinement signal is generated at block 240 as a function of the motion vectors and a display control signal. In some instances, the motion vector refinement signal is also generated as a function of the video signal (or a processed version thereof). The motion vector refinement signal includes information regarding the speed and direction of components of the video signal, as represented by the motion vectors generated at block 220 but having characteristics thereof refined to correspond to a particular video display. At block 250, a video signal is generated for displaying video on a particular video display as a function of the video signal received at block 210 (and optionally processed) and the motion vector refinement signal generated at block 240. Specifically, the video signal is generated having aspect ratio, resolution, spatio-temporal grid and other characteristics that match the particular display on which the video signal is to be displayed.

FIG. 3 is a television arrangement 300 having motion compensation circuitry, according to another example embodiment of the present invention. The television arrangement 300 includes a display 310, a front-end motion compensation circuit 320 and a display motion compensation circuit 330. A video input jack 305 receives a video input signal and passes the signal to the front-end motion compensation circuit 320, which performs motion compensation on the video input signal as a function of generated motion vectors. The front-end motion compensation circuit 320 is coupled to the display-specific motion compensation circuit 330 for passing the motion vectors and motion-compensated video. The motion compensation function performed by the front-end motion compensation circuit 320 may include, for example, one or more functions such as field or frame rate upconversion, noise reduction and deinterlacing. These functions can be implemented generally independent of the characteristics of the display 310; the front-end motion compensation circuit 320 is thus applicable to a variety of display types.

The display-specific motion compensation circuit 330 is tailored to the specific type of the display 310 (e.g., takes into consideration the spatio-temporal grid, resolution and other characteristics of the display). In most instances, the display motion compensation circuit 330 is integrated with the display 310. In other instances, the display motion compensation circuit 330 can be implemented separately from the display 310. In any instance, the display-specific motion compensation circuit 330 uses the motion vectors, modified to suit particular characteristics of the display 310, to modify the motion-compensated video (e.g., by upconverting the motion-compensated video). The modified motion-compensated video is then sent to the display 310 where it can be viewed by a user.

The present invention should not be considered limited to the particular examples described above. For example, many of the above approaches may be implemented with a variety of different types of imaging devices as an alternative or in addition to the above-discussed devices. For instance, plasma and/or DLP type displays can be used in place of the LCoS type displays discussed above. Various modifications, equivalent processes, as well as numerous structures to which the present invention may be applicable fall within the scope of the present invention, as fairly set forth in the appended claims.

1. A video image display system, comprising:
a motion estimation circuit (112) adapted to generate motion vectors as a function of an incoming video signal and stored video data (114);
a front-end motion compensation circuit (110) adapted to generate a processed video signal as a function of the incoming video signal, the motion vectors and stored video data; and
a video signal conversion circuit (134, 136) adapted to generate a display signal for a specific video display as a function of the processed video signal and the motion vectors.

2. The system of claim 1, wherein the front-end motion compensation circuit includes the motion estimation circuit.

3. The system of claim 1, wherein the front-end motion compensation circuit is an upconversion circuit.

4. The system of claim 3, wherein the upconversion circuit is adapted to convert the incoming video signal to a signal having a higher frequency and to use the motion vectors to recreate motion phases of the output video at each temporal instant.

5. The system of claim 1, wherein the front-end circuit includes a deinterlacing circuit.

6. The system of claim 1, wherein the video signal conversion circuit includes a motion vector refinement circuit adapted to process the motion vectors for use by the video signal conversion circuit.

7. The system of claim 6, wherein the motion vector refinement circuit is adapted to modify the motion vectors as a function of at least one of: the resolution and the temporal phase of a video display for which the video signal conversion circuit generates the display signal.

8. The system of claim 1, further comprising a memory adapted to store information for use by the motion front-end motion compensation circuit to store processing information for processing the incoming video signal.

9. The system of claim 1, further comprising a memory adapted to store information for use by the video signal conversion circuit to store processing information for generating the display signal.

10. The system of claim 1, wherein the video signal conversion circuit is adapted to receive a corresponding video signal from the front-end motion compensation circuit and to process the corresponding video signal by estimating spatio-temporal characteristics of components of the video signal relative to the specific video display.

11. The system of claim 10, further including means for reusing motion estimation data.

12. The system of claim 1, wherein the front-end motion compensation circuit includes computation means for implementing motion compensation functions.

13. The system of claim 12, wherein the video signal conversion circuit is adapted to receive a corresponding video signal from the front-end motion compensation circuit and to process the corresponding video signal by estimating spatio-temporal characteristics of components of the video signal relative to the specific video display.

14. The system of claim 1, wherein the front-end motion compensation circuit includes computation means for implementing high temporal refresh rate functions.

15. The system of claim 1, wherein the front-end motion compensation circuit includes computation means for implementing high resolution functions for color sequential displays.

16. The system of claim 1, wherein the front-end motion compensation circuit includes computation means for implementing high temporal refresh rate functions and for implementing the high resolution functions for color sequential displays.

17. The system of claim 16, wherein the video signal conversion circuit is adapted to receive a corresponding video signal from the front-end motion compensation circuit and to process the corresponding video signal by calculating spatio-temporal characteristics of components of the video signal relative to the specific video display.

18. For use with a video display, a method for generating video, the method comprising:
generating motion vectors as a function of an incoming video signal and stored video data;
generating a processed video signal as a function of the incoming video signal, the motion vectors and stored video data; and
generating a display signal for a specific video display as a function of the processed video signal and the motion vectors.

19. A video image display system, the method comprising:
means (112) for generating a motion vectors as a function of an incoming video signal and stored video data;
means (110) for generating a processed video signal as a function of the incoming video signal, the motion vectors and stored video data; and
means (134, 136) for generating a display signal for a specific video display as a function of the processed video signal and the motion vectors.

20. A video image display system, comprising:
a motion estimation circuit (112) adapted to generate motion vectors as a function of an incoming video signal and stored video data (114);
a front-end motion compensation circuit (110) adapted to generate a processed video signal as a function of the incoming video signal, the motion vectors and stored video data;
a scaler (120) adapted to provide a scaled video signal in response to the processed video signal; and
a video signal conversion circuit (134, 136) adapted to generate a display signal for a specific video display as a function of the scaled video signal and the motion vectors.
